(19) United States
(12) Patent Application Publication
(10) Pub. No.: US 2014/0062060 A1
(43) Pub. Date: Mar. 6, 2014

(54) Folding Wheelchair Rigidizing Device

(71) Applicant: Kyle Robert Davison, Sumner, WA (US)

(72) Inventor: Kyle Robert Davison, Sumner, WA (US)

(21) Appl. No.: 14/010,021

(22) Filed: Aug. 26, 2013

Related U.S. Application Data
(60) Provisional application No. 61/697,136, filed on Sep. 5, 2012.

(51) Int. Cl. A61G 5/10

(52) U.S. Cl. CPC A61G 5/10
USPC 280/304.1

(57) ABSTRACT

A detachable and foldable wheelchair frame rigidizing device. A pair of opposing top surfaces each includes one of a pair of opposing bottom surfaces and a cut-out pattern forming finger elements extending beyond each opposing bottom surface. The finger elements are arranged in an alternating interlocking fashion such that when the opposing top surfaces are folded together to form a planar surface the finger elements fit closely together and the opposing bottom surfaces are sized to extend beyond each of their respective top surfaces to support at least a portion of each of the finger elements from the opposing top surface when in an unfolded position. Frame attachments are attached to the perimeter of the opposing bottom surfaces. A hinge is centrally positioned to join the finger elements from each opposing top surface.

### CROSS-REFERENCE TO RELATED APPLICATION

This application is a non-provisional application of currently co-pending U.S. Provisional Patent Application No. 61/697,136, filed Sep. 5, 2012, entitled “Folding Wheelchair Rigidizing Device,” to the same inventor herein and claims the priority benefit of that filing date. Application No. 61/697,136 is incorporated by reference.

### TECHNICAL FIELD

The present invention relates to a removable rigidizing device for a folding wheelchair, more particularly, the present invention is related to a device configured so as to be locked and unlocked in at least one position, i.e. an unfolded position and/or a folded position while held in position in the wheelchair.

### BACKGROUND

When a person is in a seated position in a chair, a substantial amount of that person's weight is borne upon the sitting bones or ischial tuberosities. Particularly with respect to people using sling-seat wheelchairs, having the person's weight constantly bearing upon the seat upholstery can cause undesirable deformations such as stretching and sagging of the upholstery. This unfortunate result can, in turn, lead to further health issues that affect the wheelchair user such as postural asymmetries and related deleterious effects. Wheelchair users with general weakness and looseness of their joints are especially prone to internal rotation of their hip joints. This can cause serious conditions like pressure ulcers and malformation of bone structure.

While prior wheelchair rigidizing devices help to promote postural symmetry for persons using sling-seat wheelchairs, they do not solve some of the pressing problems inherent in using folding wheelchairs. For example, a significant drawback of such prior devices is that they are not constructed so as to allow the wheelchair to be folded while the rigidizing device is attached. Further, they do not allow for easy removal.

The present invention provides solutions for the drawbacks inherent in previous devices by providing a rigidized device adapted to mount to a folding wheelchair frame to provide a solid surface for a wheelchair user to sit while using a cushion in the chair. The rigid surface will promote postural symmetry for the user while, at the same time, allow for the option to easily remove the device or fold the chair for storage without removing the rigidizing device. The foldable and removable features of the present invention make it unique amongst other prior art.

### BRIEF SUMMARY OF THE DISCLOSURE

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention provides a detachable and foldable wheelchair frame rigidizing device. At least a pair of opposing top surfaces where each includes one of a pair of opposing bottom surfaces and a cut-out pattern forming a plurality of finger elements extending beyond each opposing bottom surface. The plurality of finger elements are arranged in an alternating interlocking fashion such that when the opposing top surfaces are folded together to form a planar surface the plurality of finger elements fit closely together and the opposing bottom surfaces are sized to extend beyond each of their respective top surfaces to support at least a portion of each of the plurality of finger elements from the opposing top surface when in an unfolded position. A plurality of frame attachments is attached to the perimeter of the opposing bottom surfaces. A hinge is centrally positioned to join the plurality of finger elements from each opposing top surface.

In one aspect, the hinge comprises a plurality of hinge leafs and a rod inserted through the plurality of hinge leafs extending through the width of all of the finger elements.

In another aspect, the plurality of frame attachments comprises open sleeves having a semi-cylindrical shape.

In another aspect, the plurality of frame attachments comprise a plastic semi-cylindrical tube.

In another aspect, each of the opposing top surfaces is made integrally with each of the opposing bottom surfaces.

In another aspect, each of the opposing top surfaces is attached to a separate opposing bottom surface.

In another aspect, each top surface is bonded to a bottom surface so that the outside edges of each surface are flush with the other.

In another aspect, the hinge includes a plurality of hinge leafs, a rod inserted through the plurality of hinge leafs extending through the width of all of the finger elements, and a plurality of retaining caps with one attached to each end of the rod.

In yet another aspect of the invention a detachable and foldable wheelchair frame rigidizing device is disclosed including at least a pair of opposing top surfaces, each opposing top surface including one of a pair of opposing bottom surfaces and a cut-out pattern forming a plurality of finger elements extending beyond each opposing bottom surface. The plurality of finger elements are arranged in an alternating interlocking fashion such that when the opposing top surfaces are folded together to form a planar surface the plurality of finger elements fit closely together and the opposing bottom surfaces are sized to extend beyond each of their respective top surfaces to support at least a portion of each of the plurality of finger elements from the opposing top surface when in an unfolded position. A plurality of frame attachments is attached to the perimeter of the opposing bottom surfaces wherein the plurality of frame attachments comprises open sleeves having a semi-cylindrical shape. A hinge is centrally positioned to join the plurality of finger elements from each opposing top surface, wherein the hinge comprises a plurality of hinge leafs and a rod inserted through the plurality of hinge leafs extending through the width of all of the finger elements.

In yet another aspect, an improvement for a folding wheelchair having a frame is disclosed having at least a pair of opposing top surfaces, each opposing top surface including one of a pair of opposing bottom surfaces and a cut-out pattern forming a plurality of finger elements extending beyond each opposing bottom surface. The plurality of finger elements are arranged in an alternating interlocking fashion such that when the opposing top surfaces are folded together to form a planar surface the plurality of finger elements fit closely together and the opposing bottom surfaces are sized to extend beyond each of their respective top surfaces to support at least a portion of each of the plurality of finger elements from the opposing top surface when in an unfolded position. A plurality of frame attachments has one side attached to the perimeter of the opposing bottom surfaces and an open side engaging the wheelchair frame. A hinge is centrally positioned to join the plurality of finger elements from each opposing top surface, whereby the hinge and opposing top and bottom surfaces are located in the seating area of the wheelchair and operate to rigidize the wheelchair when opened and fold together with the wheelchair when closed.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 is a perspective view of the top side of an example embodiment of a wheelchair rigidizing device;

FIG. 2 is a perspective view of the top side of an example embodiment of a wheelchair rigidizing device while attached to a wheelchair;

FIG. 3 is a perspective view of the bottom of an example embodiment of a wheelchair rigidizing device in a planar position (i.e. unfolded);

FIG. 4 is a perspective view of an example embodiment of a wheelchair rigidizing device in a semi-folded position; and

FIG. 5 is a perspective view of an example of a fully folded wheelchair with a wheelchair rigidizing device attached.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several embodiments for a folding wheel chair rigidizing device. Several features of methods and systems in accordance with example embodiments are set forth and described in the Figures. It will be appreciated that methods and systems in accordance with other example embodiments can include additional procedures or features different than those shown in the Figures. Example embodiments are described herein with respect to a folding rigidizing device. However, it will be understood that these examples are for the purpose of illustrating the principles, and that the invention is not so limited. Additionally, methods and systems in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or combinations and/or variations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

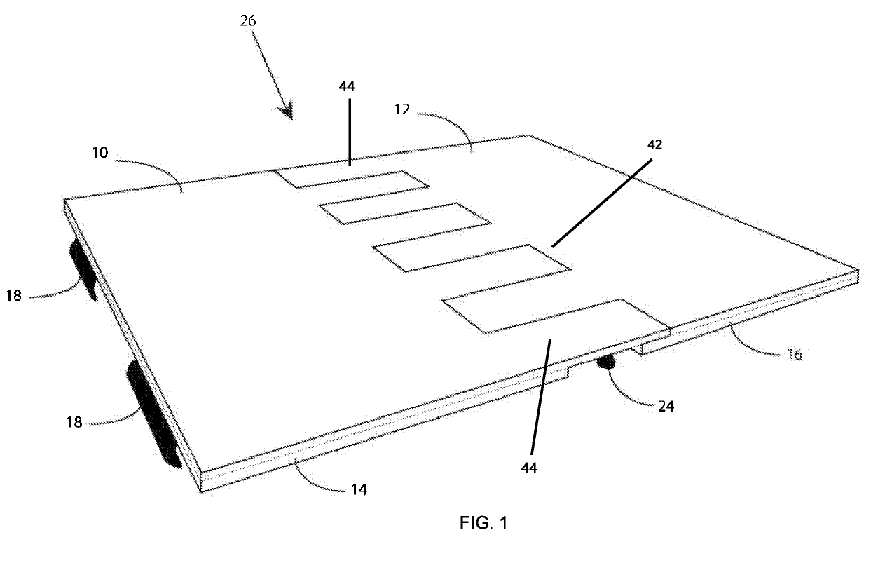

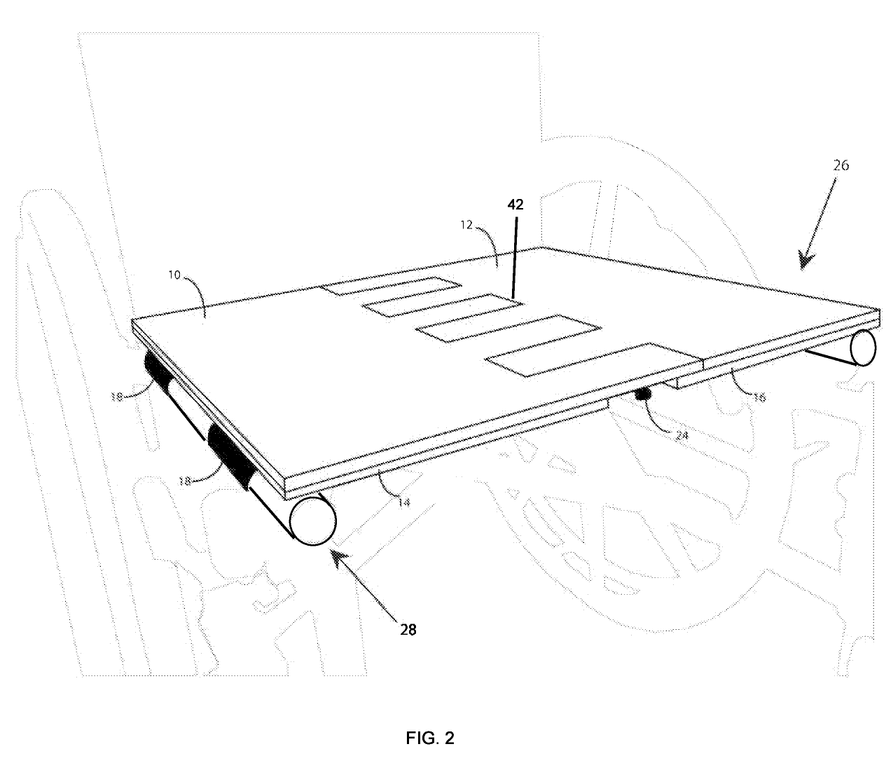

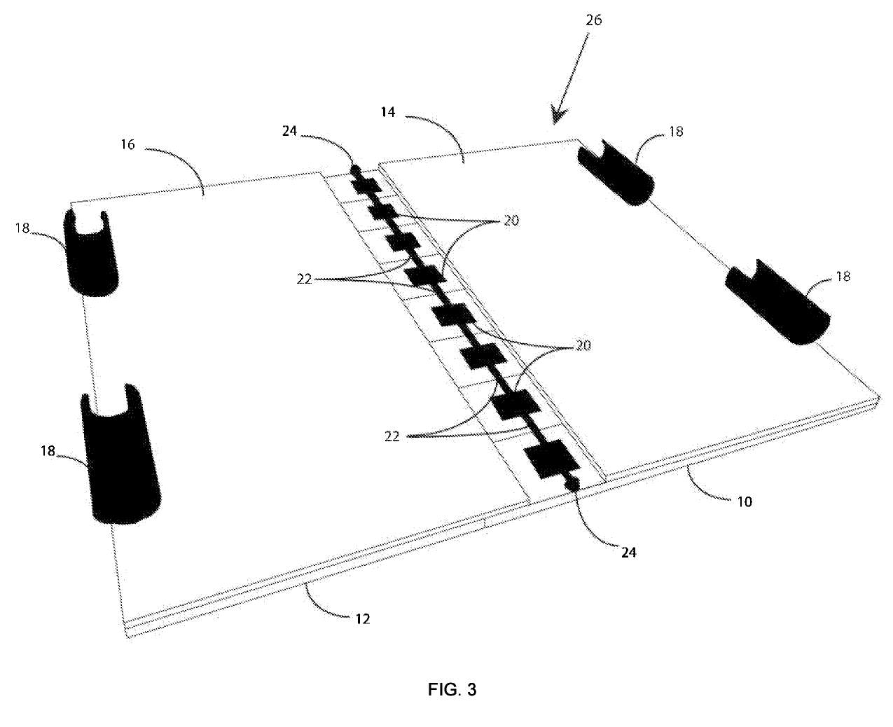

Referring now jointly to FIG. 1 and FIG. 2, perspective views of the top side of an example embodiment of a wheelchair rigidizing device are shown. At least a pair of opposing top surfaces 10, 12 each include one of a pair of opposing bottom surfaces 14, 16 and a cut-out pattern 42 forming a plurality of finger elements 44 extending beyond each opposing bottom surface 14, 16. The plurality of finger elements 44 are arranged in an alternating interlocking fashion such that when the opposing top surfaces 10, 12 are folded together to form a planar surface the plurality of finger elements 44 fit closely together and the opposing bottom surfaces 14, 16 are sized to extend beyond each of their respective top surfaces 10, 12 to support at least a portion of each of the plurality of finger elements 42 from the opposing top surface 10 or 12 as the case may be when in an unfolded or planar position. A plurality of frame attachments 18 are attached to the perimeter of the opposing bottom surfaces 14, 16. A hinge is centrally positioned to join the plurality of finger elements from each opposing top surface. In one useful embodiment, a plurality of nut caps 24 may be employed to secure a rod 22 (shown in FIG. 3).

Referring now specifically to FIG. 2, the positioning and fit of a rigidizing device on a folding wheelchair is illustrated. The rigidizing device 26 has a cut-out pattern 42 that separates top surface 10 from opposing top surface 12 allowing each top surface 10, 12, to share equal surface area. Cut-out pattern 42 includes a plurality of interlocking finger members 44. The rigidizing device 26, as shown in a planar position, is designed to provide rigidity to a sling-seat wheel chair by optionally removing the seat upholstery and attaching the rigidizing device with the plurality of frame attachments 18 to the wheelchair frame 28. The top surface 10 is bonded to the bottom surface 14 allowing the outside edges to be flush. The top surface 12 is bonded to the bottom surface 16 preferably allowing the outside edges to be flush. When the top surface 10 and the bottom surface 14 are joined together with top surface 12 and bottom surface 16, top surface 10 will rest on bottom surface 14 and top surface 12 will in turn rest on bottom surface 16 creating an interlocked planar seating surface. A nut cap 24 is shown securing and capping a rod 22 (as shown in FIG. 3).

Referring now to FIG. 3 a perspective view of the bottom of an example embodiment of a wheelchair rigidizing device in a planar position is shown. Bottom surfaces 14 and 16 now are shown in more detail allowing a better view of how the plurality of frame attachments 18 may be aligned along the outer perimeter of bottom surfaces 14 and 16. The rod 22 and hinge leafs 20 are shown attached in a conventional manner to the underside of opposing top surfaces 10, 12 in the center of the rigidizing device 26. Nut caps 24 may be used to secure rod 22 in place. The hinge leafs 20 are bonded to the underside of top surfaces 10 and 12 and each leaf includes a channel to allow rod 22 to pass through each channel 20 so that the hinge leafs and rod 22 operate together as a hinge for folding the rigidizing device 26, with rod 22 serving as the hinge pin. Nut caps 24 keep the rod 22 from sliding out of position. The plurality of frame attachments 18 may advantageously be made in as open sleeves having a semi-cylindrical shape, allow the wheelchair frame 28 to fit inside frame attachments 18.

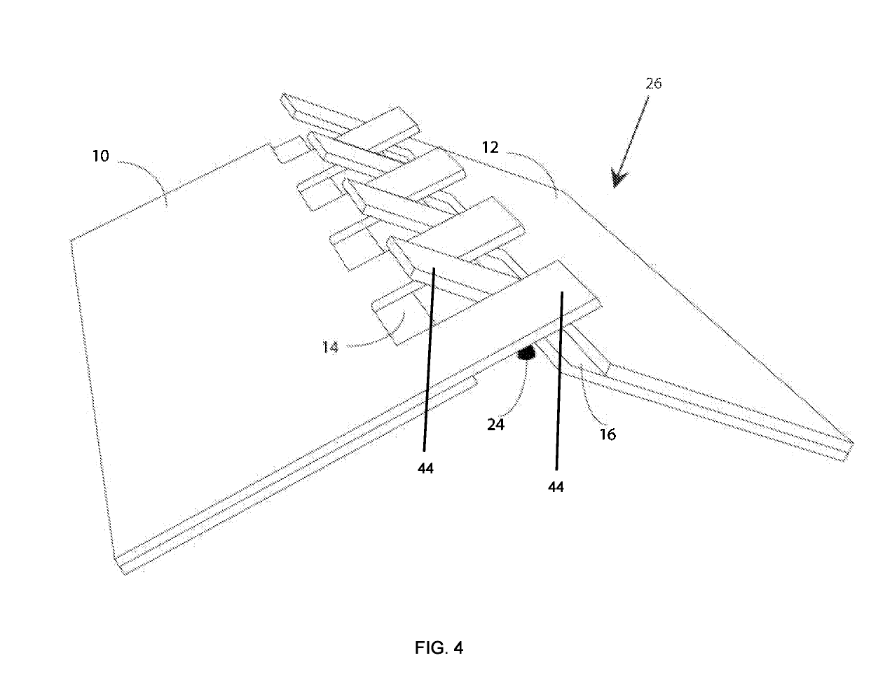

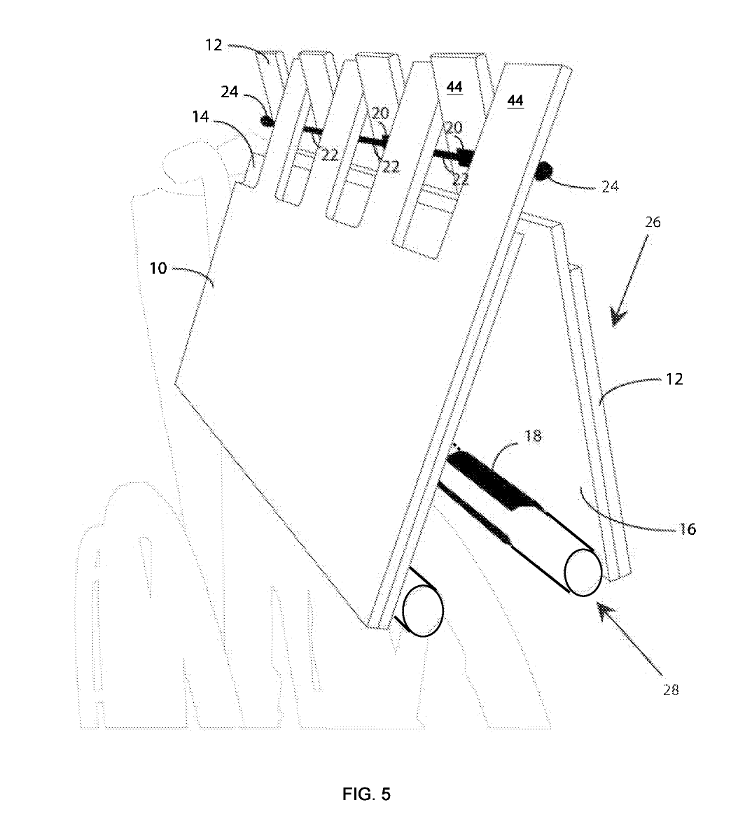

Referring now jointly to FIG. 4 and FIG. 5 perspective views of an example embodiment of a wheelchair rigidizing device in a semi-folded position apart from and attached to a wheelchair are shown respectively. With particular reference to FIG. 4 it can been seen how top surfaces 10, 12 can be operated to pivot on the hinge system of rod 22 and hinge leafs 20 (as best shown in FIG. 3), causing the extruded members of opposing top surfaces 10 and 12 to interlock when opened into a planar position for seating as shown in FIG. 1, for example. Bottom surfaces 14 and 16 provide support for the cut-out finger members 44 of top surface 10 and 12 when in the planar position.

Referring particularly to FIG. 5, a fully folded rigidizing device 26 with top surfaces 10 and 12 facing opposite directions while mounted on folding wheelchair frame 28 with the plurality of frame attachments 18. Also visible are the rod 22 and hinge leafs 20 as well as nut cap 24 that make up the hinge system which allows the rigidizing device 26 to fold. Frame attachments 18 keep the rigidizing device 26 attached to the wheelchair frame 28 while in the flat position and folded position. In operation, folding the wheelchair with the rigidizing device 26 attached to the wheelchair frame 28 will cause the rigidizing device to fold with the wheelchair, enabling folding both in one motion. The center of the rigidizing device 26 fold upwards at the hinge after an inward force is applied to the wheelchair frame 28.

One example embodiment as shown in FIG. 1-FIG. 5, includes a top surface 10 and bottom surface 14 are fit together with top surface 12 and bottom surface 16. They form the planar rigidizing seating surface of the rigidizing device 26 which may advantageously be sufficiently wide and long enough to fit on various sizes of sling-seat wheelchair frames, such as about 18 by 16 inches or about 20 by 18 inches in width and depth. It will be appreciated that the width and depth selected will be selected to match the width and depth of the intended wheelchair. Frame attachments 18, which are attached to the underside of bottom surfaces 14 and 16 on the outer edges, allow the rigidizing device 26 to be attached to the wheelchair frame 28 of a sling-seat wheelchair and may advantageously be sufficiently wide enough to allow for the wheelchair frame 28 to fit inside the openings of the frame attachments 18. Nut caps 24 which are large enough to cap the rod 22 are fastened to the each end of the rod 22 to keep it in place. The length of rod 22 is sufficiently long enough to span the depth of the planar rigidizing surface. The hinge leafs 20 may advantageously be sufficiently wide enough to allow for the rod 22 to pass through. The hinge system comprising of hinge leafs 20, rod 22 and nut caps 24 may preferably be sufficiently sized to allow for maximum range of the pivoting motion of the rigidizing device 26.

Having described the invention above, it is now considered useful to the understanding of the invention to describe further aspects of the construction details of one example embodiment. The top surfaces 10, 12 and bottom surfaces 14, 16 can be made of rigid plastic but could also be made of metal, wood, any other sufficiently rigid and strong material, combinations of these and the like as known to those skilled in the art. While the top surfaces 10, 12 and bottom surfaces 14, 16 have been illustrated as flat surfaces, in an alternate embodiment stabilizing ridges or any other rigidizing material could be added to increase rigidity. Further, top surface 10 can be bonded to bottom surface 14 and top surface 12 can be bonded to bottom surface 16 with plastic cement or equivalents but the top surfaces 10, 12 could be attached to the bottom surfaces 14, 16 in any sufficient manner to keep them as one unit. The top surfaces 10, 12 and bottom surfaces 14, 16 could even be manufactured as one solid piece.

Frame attachments 18 as shown may be advantageously comprised of a rigid plastic, semi-cylindrical tube that has been designed to be able to flex around a wheelchair frame 28. Frame attachments 18 could, however, be comprised of any moderately flexible material that would allow a wheelchair frame 28 to fit inside. The frame attachments 18 as shown are bonded to bottom surfaces 14, 16 in a fixed position but they could be fastened to the bottom surfaces 14, 16 in multiple positions. The frame attachments 18 could also be comprise of a quick-release, multi-positional, fastener, made of metal, plastic or the like, designed to securely attach to a wheelchair frame 28 and bottom surfaces 14 and 16 but still allow quick removal of the rigidizing device 26 from the wheelchair frame 28. The rod 22 as shown is preferably made of steel but could also be made of another rigid material that could serve as a pin element for a hinge system. The hinge leafs 20 maybe made of metal but could be comprised of rigid plastic, wood or equivalents and attached in a linear position to the underside of top surfaces 10 and 12. Nut caps 24 as shown can be comprised of metal but could also be comprised of plastic, nylon or equivalents or any other material that would sufficiently hold the rod 22 in place. The hinge system could also be comprised of any other system that would serve as the fulcrum or hinge for the rigidizing device 26.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by different equipment, and devices, and that various modifications, both as to the equipment details and operating procedures, may be accomplished without departing from the true spirit and scope of the present invention.

What is claimed is:

1. A detachable and foldable wheelchair frame rigidizing device comprising:
at least a pair of opposing top surfaces, each opposing top surface including one of a pair of opposing bottom surfaces and a cut-out pattern forming a plurality of finger elements extending beyond each opposing bottom surface;
the plurality of finger elements are arranged in an alternating interlocking fashion such that when the opposing top surfaces are folded together to form a planar surface the plurality of finger elements fit closely together and the opposing bottom surfaces are sized to extend beyond each of their respective top surfaces to support at least a portion of each of the plurality of finger elements from the opposing top surface when in an unfolded position;
a plurality of frame attachments attached to the perimeter of the opposing bottom surfaces; and
a hinge centrally positioned to join the plurality of finger elements from each opposing top surface.

2. The device of claim 1 wherein the hinge comprises a plurality of hinge leafs and a rod inserted through the plurality of hinge leafs extending through the width of all of the finger elements.

3. The device of claim 1 wherein the plurality of frame attachments comprise open sleeves having a semi-cylindrical shape.

4. The device of claim 3 wherein the plurality of frame attachments comprise a plastic semi-cylindrical tube.

5. The device of claim 1 wherein each of the opposing top surfaces is made integrally with each of the opposing bottom surfaces.

6. The device of claim 1 wherein each of the opposing top surfaces is attached to a separate opposing bottom surface.

7. The device of claim 6 wherein each top surface is bonded to a bottom surface so that the outside edges of each surface is flush with the other.

8. The device of claim 1 wherein the hinge comprises:
a plurality of hinge leafs;
a rod inserted through the plurality of hinge leafs extending through the width of all of the finger elements; and
a plurality of retaining caps with one attached to each end of the rod.

9. A detachable and foldable wheelchair frame rigidizing device comprising:
at least a pair of opposing top surfaces, each opposing top surface including one of a pair of opposing bottom surfaces and a cut-out pattern forming a plurality of finger elements extending beyond each opposing bottom surface;
the plurality of finger elements are arranged in an alternating interlocking fashion such that when the opposing top surfaces are folded together to form a planar surface the plurality of finger elements fit closely together and the opposing bottom surfaces are sized to extend beyond each of their respective top surfaces to support at least a portion of each of the plurality of finger elements from the opposing top surface when in an unfolded position;
a plurality of frame attachments attached to the perimeter of the opposing bottom surfaces wherein the plurality of frame attachments comprise open sleeves having a semi-cylindrical shape; and
a hinge centrally positioned to join the plurality of finger elements from each opposing top surface, wherein the hinge comprises a plurality of hinge leafs and a rod inserted through the plurality of hinge leafs extending through the width of all of the finger elements.

10. The device of claim 9 wherein the plurality of frame attachments comprise a plastic semi-cylindrical tube.

11. The device of claim 9 wherein each of the opposing top surfaces is made integrally with each of the opposing bottom surfaces.

12. The device of claim 9 wherein each of the opposing top surfaces is attached to a separate opposing bottom surface.

13. The device of claim 9 wherein each top surface is bonded to a bottom surface so that the outside edges of each surface are flush with the other.

14. The device of claim 9 wherein the hinge further comprises a plurality of retaining caps with one attached to each end of the rod.

15. An improvement for a folding wheelchair having a frame comprising:
at least a pair of opposing top surfaces, each opposing top surface including one of a pair of opposing bottom surfaces and a cut-out pattern forming a plurality of finger elements extending beyond each opposing bottom surface;
the plurality of finger elements are arranged in an alternating interlocking fashion such that when the opposing top surfaces are folded together to form a planar surface the plurality of finger elements fit closely together and the opposing bottom surfaces are sized to extend beyond each of their respective top surfaces to support at least a portion of each of the plurality of finger elements from the opposing top surface when in an unfolded position;
a plurality of frame attachments having one side attached to the perimeter of the opposing bottom surfaces and an open side engaging the wheelchair frame; and
a hinge centrally positioned to join the plurality of finger elements from each opposing top surface, whereby the hinge and opposing top and bottom surfaces are located in the seating area of the wheelchair and operate to rigidize the wheelchair when opened and fold together with the wheelchair when closed.

16. The wheelchair of claim 15 wherein the hinge comprises a plurality of hinge leafs and a rod inserted through the plurality of hinge leafs extending through the width of all of the finger elements.

17. The wheelchair of claim 15 wherein the plurality of frame attachments comprise open sleeves having a semi-cylindrical shape.

18. The wheelchair of claim 17 wherein the plurality of frame attachments comprise a plastic semi-cylindrical tube.

19. The wheelchair of claim 15 wherein each of the opposing top surfaces is made integrally with each of the opposing bottom surfaces.

20. The wheelchair of claim 15 wherein the hinge comprises:
a plurality of hinge leafs;
a rod inserted through the plurality of hinge leafs extending through the width of all of the finger elements; and
a plurality of retaining caps with one attached to each end of the rod.
